(19) United States
(12) Patent Application Publication
(10) Pub. No.: US 2019/0018227 A1
(43) Pub. Date: Jan. 17, 2019

(54) LARGE APERTURE, HIGH-SPEED OPTICAL TAGS

(71) Applicant: Cubic Corporation, San Diego, CA (US)

(72) Inventors: Tony Maryfield, Poway, CA (US); Mahyar Dadkhah, San Diego, CA (US); Richard G. Trissel, Gualala, CA (US); Michael Roes, San Diego, CA (US)

(73) Assignee: Cubic Corporation, San Diego, CA (US)

(21) Appl. No.: 16/027,962

(22) Filed: Jul. 5, 2018

Related U.S. Application Data
(60) Provisional application No. 62/531,268, filed on Jul. 11, 2017.

(51) Int. Cl. G02B 13/06; G02B 27/09; G02B 7/02

(52) U.S. Cl. CPC G02B 13/06; G02B 7/02; G02B 27/0977

(57) ABSTRACT

Embodiments disclosed herein address these and other issues by providing a retro-modulating optical “tag” with a wide FOV that enables high-speed communication in a compact design. Embodiments enable retro-modulation via a lens assembly that directs light to a reflective surface, through a Quantum Well Modulator (QWM) that modulates the light. A wide field of view can be achievable, for example, using a lens with a high index of refraction, which may be optically contacted with the QWM.

### CROSS-REFERENCES TO RELATED APPLICATIONS

This application claims the benefit of U.S. Provisional Patent Application No. 62/531,268, filed Jul. 11, 2017, entitled “LARGE APERTURE, HIGH-SPEED OPTICAL TAGS,” which is assigned to the assignee hereof and incorporated by reference herein in its entirety.

### BACKGROUND

Optical communication can have various advantages over radio frequency (RF) communication in many different applications. For example, optical communication can provide directional communication with little or often with higher data rates than RF communication and less susceptibility to jamming or other interference. It can also provide other advantages, such as reduced radiation hazard and power consumption. As such, optical communication can be a preferred type of communication in military and other applications.

However, the implementation of effective optical systems can be difficult. Trade-offs related to optical aperture, field of view (FOV), and size of optical components can make it difficult to provide a compact, low-power optical device that can effectively communicate at long distances.

### BRIEF SUMMARY

Embodiments disclosed herein address these and other issues by providing a retro-modulating optical “tag” with a wide FOV that enables high-speed communication in a compact design. Embodiments enable retro-modulation via a lens assembly that directs light to a reflective surface, through a Quantum Well Modulator (QWM) that modulates the light. A wide field of view can be achievable, for example, using a lens with a high index of refraction, which may be optically contacted with the QWM.

An example embodiment of an optical retro-modulator, according to the description, comprises a lens assembly comprising at least one lens configured to direct incoming light toward a focal point, a substantially flat optically reflective element disposed at the focal point of the lens assembly and configured to reflect the incoming light from the lens assembly back toward the lens assembly, and a Quantum Well Modulator (QWM) disposed between the lens assembly and the optically reflective element and configured to modulate the incoming light, the reflected light, or both, traveling between the lens assembly and the optically reflective element.

Embodiments of an optical retro-modulator may comprise one or more of the following features. The lens assembly further may be configured to direct the incoming light toward the focal point telecentrically, when the optical retro-modulator is used with an aperture stop. The QWM may comprise a semiconductor device, and the optically reflective element may be disposed on a surface of the semiconductor device such that the incoming light from the lens assembly travels through the semiconductor device. The lens assembly may comprise an immersion lens optically contacted with the semiconductor device. The lens assembly may further comprise a corrector lens configured to direct the incoming light toward the immersion lens. The optically reflective element may comprise a metallic layer deposited on the surface of the optical element. The metallic layer may comprise gold. The lens assembly may comprise a silicon lens.

An example method of optical retro-modulation, according to the description, comprises using a lens assembly comprising at least one lens to direct incoming light incident on the lens assembly toward a focal point of the lens assembly, reflecting the incoming light back toward the lens assembly using a substantially flat optically reflective element disposed at the focal point of the lens assembly, and modulating the incoming light, the reflected light, or both, using a Quantum Well Modulator (QWM) disposed between the lens assembly and the optically reflective element.

Embodiments of a method of optical retro-modulation may include one or more the following features. The method may further comprise providing an aperture stop such that the lens assembly is configured to direct the incoming light toward the focal point of the lens assembly telecentrically. The QWM may comprise a semiconductor device, and the optically reflective element may be disposed on a surface of the semiconductor device such that the incoming light from the lens assembly travels through the semiconductor device. The lens assembly may comprise an immersion lens optically contacted with the semiconductor device. The lens assembly may further comprise a corrector lens configured to direct the incoming light toward the immersion lens. The optically reflective element may further comprise a metallic layer deposited on the surface of the semiconductor device.

An example optical device, according to the description, comprises a lens assembly comprising a corrector lens and an immersion lens, the lens assembly configured to enable incoming light incident on the corrector lens to be directed toward a focal point of the lens assembly telecentrically. The optical device further comprises an optically reflective element disposed at the focal point of the lens assembly configured to reflect the incoming light from the lens assembly back toward the lens assembly, and a modulating optical element disposed between the lens assembly and the optically reflective element. The modulating optical element is coupled to the immersion lens of the lens assembly via an optical contact bond, and the modulating optical element comprises a Quantum Well Modulator (QWM) configured to modulate the incoming light, the reflected light, or both, traveling between the lens assembly and the optically reflective element.

Embodiments of an optical device may further comprise one or more the following features. The optically reflective element may comprise a metallic layer disposed on a surface of the modulating optical element. The metallic layer may comprise gold. The immersion lens may comprise a silicon lens.

### BRIEF DESCRIPTION OF THE DRAWINGS

For a more complete understanding of this invention, reference is now made to the following detailed description of the embodiments as illustrated in the accompanying drawings, in which like reference designations represent like features throughout the several views and wherein:

FIG. 1 is an illustration of an example optical communication system in a military application;

FIG. 2 is a simplified illustration of optical configurations provided to help illustrate trade-offs that can limit the functionality of optical retro-modulators;

FIG. 3 is an illustration of an optical retro-modulator, according to an embodiment;

FIG. 4 is an illustration of an embodiment of an optical tag, according to an embodiment;

FIG. 5 is a block diagram of the electrical components of an optical tag, according to an embodiment; and

FIG. 6 is a process flow diagram of a method 600 of optical retro-modulation, according to an embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any or all of the similar components having the same first reference label irrespective of the second reference label.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Optical communication systems can be utilized in a wide variety of military, commercial, consumer, and/or other applications. Optical communication systems can include both “active” and “passive” components: where active components emit light, and passive components do not. Even so, passive components (also referred to herein as optical “tags”) may still communicate with active components through retro-modulation, by modulating retro-reflected light received from active components of the optical communication system. That is, optical tags may include optical detectors that enable receipt of information via modulated light, and may also include retro-modulators to allow the tags to communicate back to an active device. For example, to obtain information from an optical tag, an active component may illuminate (e.g., with laser light) the optical tag, which communicates back to the active component by reflecting and modulating the laser light, encoding data on the modulated return signal. The active component may then, using a detector, receive modulated signal.

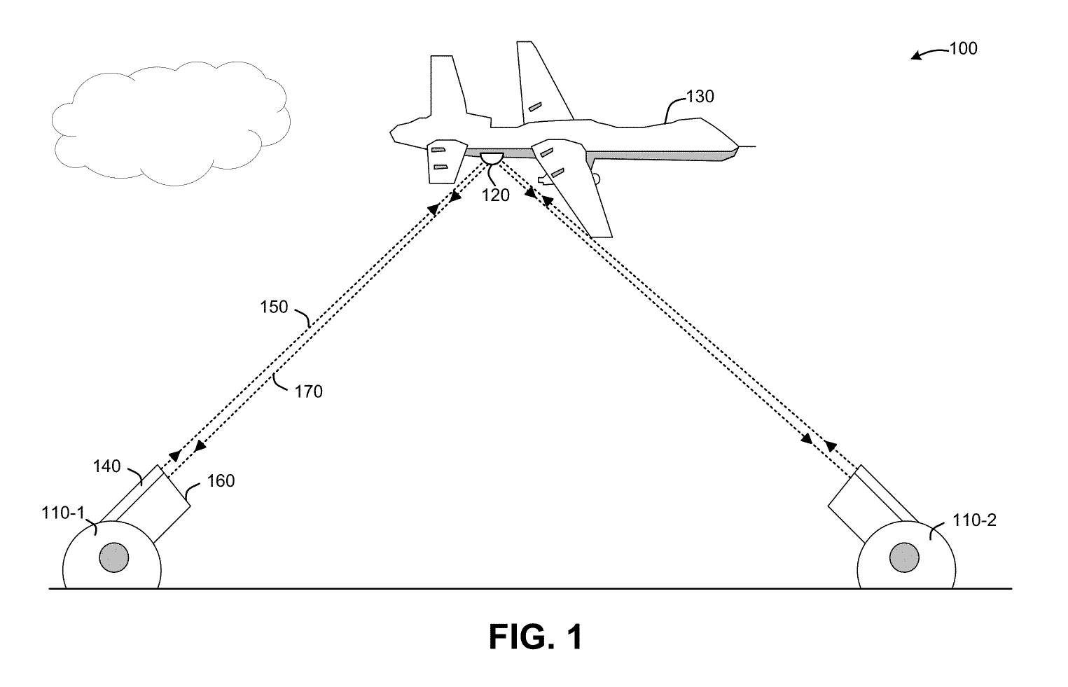

FIG. 1 is an illustration of an example optical communication system in a military application. Here, ground-based communication terminals 110-1 and 110-2 (collectively and generically referred to herein as communication terminals 110) are active optical components that communicate with a passive optical tag 120 on an aerial vehicle 130. More specifically, the communication terminals 110 comprise a laser transmitter unit that emits a laser light 150 that illuminates the tag 120, and a receiver unit 160 that detects the reflected laser light 170. The optical tag 120 modulates the laser light to encode the reflected laser light 170 with data, which can be decoded by the communication terminals 110. The communication terminals 110 can also modulate the laser light 150 with data that is detected by the optical tag 120, thereby enabling two-way communications between the communication terminals 110 and the passive tag 120. Of course, FIG. 1 illustrates just one application of an optical communication system in which optical tags 120 may be utilized. Optical tags 120 can be utilized in ground-based military applications, commercial applications, consumer applications, and more. In alternative embodiments, an area vehicle 130 (or other object, which may be stationary or moving) may have multiple tags 120. Moreover, different optical channels may be used by using laser transmitter units 140, optical tags 120, and receiver units 160 that use different frequencies of laser light.

In many applications, having long-range optical links between communication terminals 110 and tags 120 can be very important. In the case of aerial vehicles 130, for example, ultra-long-range optical links up to and/or exceeding 150 km may be desirable in some cases. This can be especially challenging when dealing with passive optical tags 120, because laser light travels twice as far (round trip from the communication terminals 110 to the optical tag 120 and back) as it would if active optical tags were used (a one-way trip in which case laser light would only have to travel the distance between the communication terminals 110 and the active optical tag). With this in mind, reducing the beam divergence of the reflected laser light 170 can be very important. And because divergence is inversely proportional to the aperture size of the optical tag, increasing the diameter of the aperture of the tag 120 is therefore desirable.

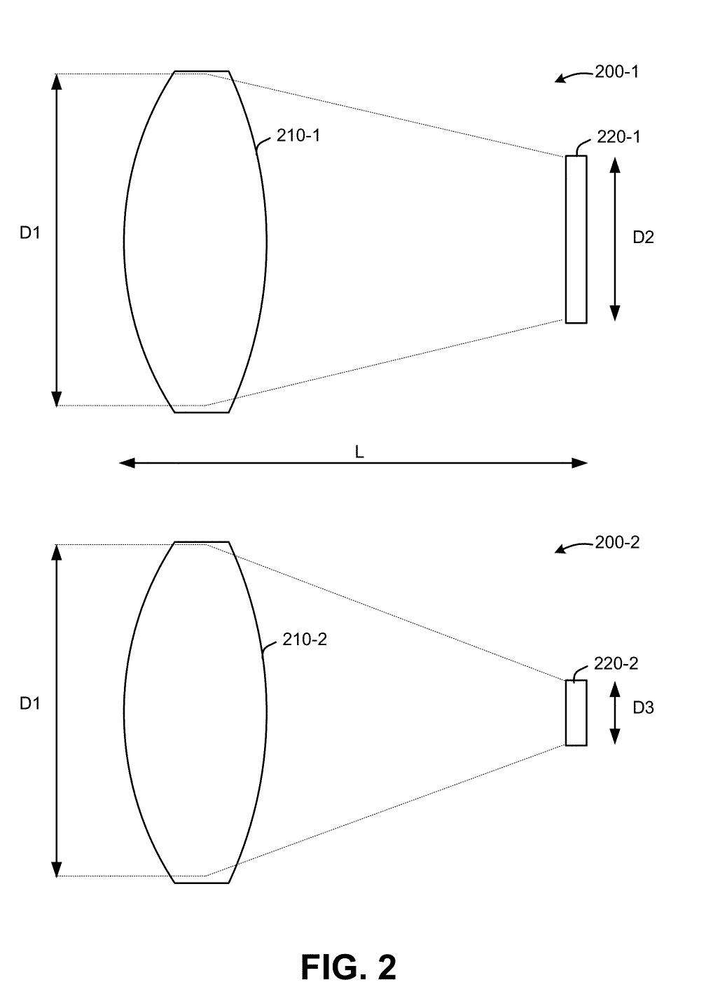

Problematically, trade-offs related to optical aperture, field of view (FOV), and size of optical components can make reducing beam divergence difficult. FIG. 2 helps illustrate these tradeoffs.

FIG. 2 is a simplified illustration of optical configurations 200-1 and 200-2 (generically and collectively referred to herein as configurations 200) provided to help illustrate trade-offs that can limit the functionality of optical retro-modulators in optical tags 120. Here, optical retro-modulators are represented by a single lens 210 and modulating element 220, although a person of ordinary skill in the art will appreciate that optical retro-modulators (and the optical tags in which the optical retro-modulators are disposed) may comprise additional components.

As previously mentioned, trade-offs exist between device size (represented here as having length L), optical aperture size (represented as having diameter D1), modulating element diameter (diameters D2 and D3 for respective configurations 200-1 and 200-2), and FOV. For example, for a device having a given length L, aperture diameter D1, and FOV, the diameter of the modulating element 220 may be limited by the focal power of the lens 210. In the first configuration 200-1, the focal length of the first lens 210-1 is longer than the focal length of the lens 210-2 of the second configuration 220-2. As such, the diameter D2 of the first modulating element 220-1 must be bigger than the diameter D3 of the second modulating element 220-2. (Of course, a smaller modulating element could be used in the first configuration 200-1 by increasing the length L of the device, and/or decreasing the aperture diameter D1 and/or FOV. But this could result in an undesirable device length and/or reduced performance.)

The use of a modulating element 220 having a smaller diameter has additional advantages. Reducing the size of a modulating element 220 can reduce capacitance that can limit the speed of modulation. Thus, smaller modulating elements 220 can result in higher modulation speeds. In some embodiments, for example, modulation speeds of 1 Gbps may be achievable in configurations where modulating element diameter (e.g., D2, D3) is 0.25 mm and aperture diameter (e.g., D1) is 20 mm. Higher modulation speeds may be attainable using a smaller modulating element and/or implementing other speed-increasing techniques (e.g., utilizing modulating elements with lower switching voltages).

Additionally, modulating elements 220 may comprise semiconductor devices. As such, they can additionally benefit from the advantages in semiconductor manufacturing that come with smaller device size, primarily due to the fact that production yields tend to increase as device sizes decrease (e.g., due to an increased amount of devices per wafer and a decrease in percentage of defective devices).

Thus, in view of the principles illustrated in FIG. 2, it may be desirable for an optical retro-modulator to have a high ratio of aperture-size diameter to modulating-element diameter (e.g., ratio D1:D3 or D1:D2).

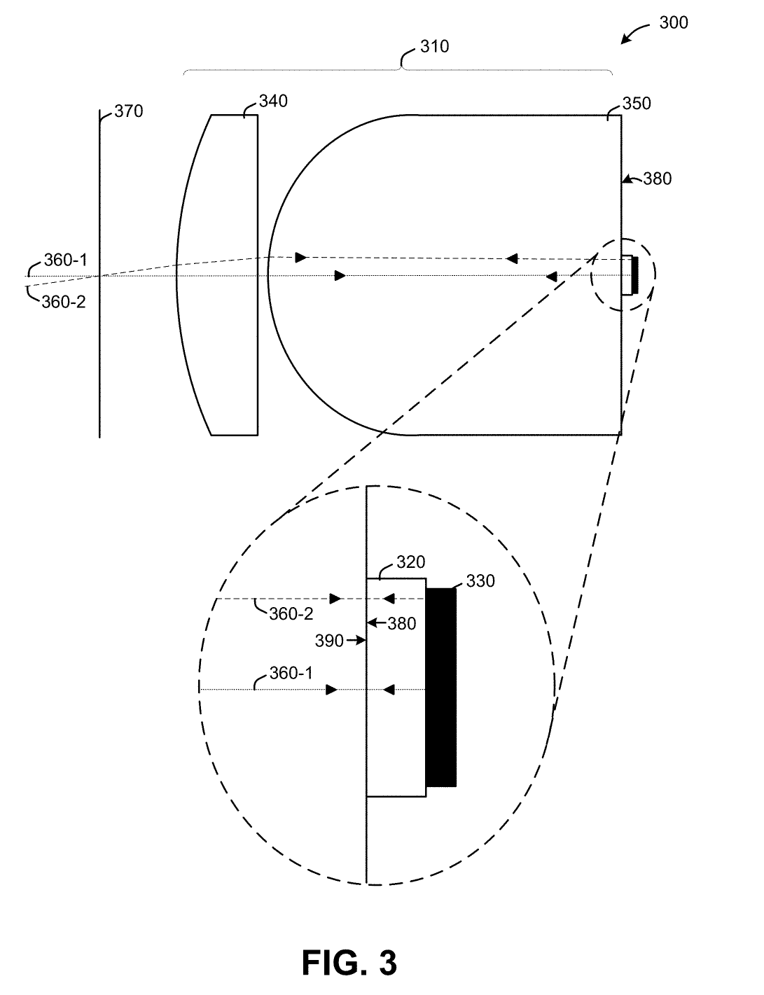

FIG. 3 is an illustration of an optical retro-modulator 300, according to an embodiment. Here, the optical retro-modulator 300 comprises a lens assembly 310, Quantum Well Modulator (QWM) 320, and reflective element 330. A person of ordinary skill in the art will appreciate how alternative embodiments may vary. For example, although the lens assembly 310 is a two-lens assembly comprising a first lens 340 and a second lens 350, alternative embodiments may comprise only a single lens or may have a larger number of lenses. Here, an aperture stop 370 may be used to help achieve telecentricity (which will be discussed in more detail below). Depending on desired functionality, the aperture stop 370 (if used) may be included as part of the optical retro-modulator 300 (e.g., in a discrete device) or may be included in a larger optical assembly in which the optical retro-modulator 300 is used.

In this embodiment, a high aperture-size diameter to modulating-element diameter can be achieved by shortening the focal point of the lens assembly 310 with the second lens 350, which may have a relatively high index of refraction. In some embodiments, for example, the second lens 350 may comprise a silicon lens.

According to embodiments, the reflective element 330 may be coupled to a surface of the QWM 320 enabling the optical retro-modulator 300 to utilize a flip-chip configuration in which incoming light rays 360-1, 360-2 (collectively and generically referred to herein as light rays 360, or simply light 360) incident on the lens assembly 310 travel through the QWM 320 and reflect off of the reflective element 330, back in the same direction it came. The reflective element may be located at the focal point of the lens assembly 310. As illustrated, the QWM 320 may be “optically contacted” with the second lens 350, causing the second lens 350 to function as an immersion lens and, where the QWM 320 has an index of refraction similar to the index of refraction of the second lens 350, preserving a wide FOV by keeping the beam bundle in high index media. Even so, alternative embodiments may utilize configurations in which no immersion lens is used. (An immersion lens may not be used, for example, in applications where a wide FOV is not needed.) Additionally, it should be noted that the components shown in FIG. 3 are illustrative. The actual size and shape of components may differ from those shown. (For example, in some embodiments, the ratio of aperture-size diameter to modulating-element (QWM) diameter may be 80:1, meaning that the QWM 320 may be much smaller, relative to the lens assembly 310, than illustrated.)

In one embodiment, in which the QWM 320 is optically contacted with the second lens 350, the manufacturing processes can result in the polishing the contacting surface 380 of the lens 350 and surface 390 of the QWM 320 to a roughness of less than 50 angstroms. (Alternative embodiments may employ manufacturing processes resulting in a different amount of roughness.) These surfaces 380 and 390 are then “optically contacted,” joined such that they make full edge-two-edge contact without any air in between, creating an optical contact bond between the materials (which is believed to be due to intermolecular forces). The second lens 350 and QWM 320 will then “stick” to each other and may be further supported with an annulus of epoxy to retain position. In this example manufacturing process, precision placement fixtures can help ensure that the QWM 320 is placed with positional accuracy of at least 10 μm. (Alternative embodiments may have alternative accuracies.) This can ensure that a center entering the lens (e.g., chief ray 360-1 of an on-axis field point) aligns with the center aperture of the QWM 320 for full field of view. (That said, alternative embodiments may utilize a non-immersion lens, without optically contacting the positive lens with the QWM 320.)

FIG. 3 further illustrates incoming light 360 is retro-reflected (i.e., reflected light travels back along the same path as the incident light), through telecentricity. That is, the lens assembly 310 may operate with a stop 370 to ensure that chief rays of incoming light 360 are directed to the reflective element 330 such that, when incident on the reflective element 330, they are normal to the reflective element 330. For example, not only is a chief ray 360-1 of an on-axis field point (e.g., from a first laser source) incident on the optical retro-modulator 300 normal to the reflective element 330, but so is the chief ray 360-2 of an off-axis field point (e.g., from a second light source) incident on the optical retro-modulator 300. As noted above, the stop 370, which may be used to help achieve telecentricity, may or may not be integrated into the optical retro-modulator 300.

In some embodiments, for example, the stop 370 may comprise a pupil or other optical element within a separate optical assembly that directs the light toward the optical retro-modulator 300. For example, in some embodiments, an optical tag may comprise a telescope that collects incoming light and directs a portion of the light toward the optical retro-modulator 300 (another portion of the light may be directed toward a separate optical receiver that may be used to detect light and decode data that may be encoded on the light through modulation). In this example, the stop 370 may actually comprise a pupil within the telescope and separate from the optical retro-modulator 300.

The QWM 320 may comprise a semiconductor device configured to modulate an amplitude of the light 360 with one or more quantum well structures. These structures can use, for example, electro-absorption to modulate the light by changing an amount of light absorption of the QWM 320 when a switching voltage is applied. The material(s) used for the QWM 320 may vary, depending on factors such as index of refraction and/or other optical properties (which may vary, depending on the wavelength of incoming light 360 used in optical communication), electronic properties, manufacturing concerns, and the like. (In some embodiments, for example, an InGaAs QWM 320 is used.) As previously mentioned, as the size of the quantum well is reduced, higher speeds (and higher yields during manufacture) may be achieved. For example, for a larger device in which the QWM 320 has a 6.3 mm active pixel (with a 76 pF capacitance), a modulation rate of 1.45 Mbps is achievable. However, when reduced to a 0.25 mm active pixel (with a 1.1 pF capacitance on a 1×1 mm die 350 microns thick), a 1000 Mbps (1 Gbps) modulation rate is achievable. A person of ordinary skill in the art will appreciate that different properties of the QWM 320 may affect the modulation rate, switching voltage, and overall performance.

The performance of the QWM 320 may be temperature dependent. As such, some embodiments may include a temperature sensor (not shown in FIG. 3) that senses a temperature of the QWM 320 and adjusts a bias voltage to ensure the QWM 320 provides a sufficient (or optimal) modulation depth. It can be additionally noted that an immersion design, in which the QWM 320 is optically contacted with the second lens 350, may be additionally advantageous because it can enable the second lens 350 to also serve as a heatsink, dissipating heat generated by the QWM 320. Embodiments may employ these and/or other techniques to compensate for temperature change and enable the optical retro-modulator 300 to perform over a larger range of temperatures.

The reflective element 330 may comprise a metal or other reflective material. In some embodiments, the reflective element 330 may comprise a metallic layer deposited on the back surface of the QWM 320 during manufacture of the QWM 320 and/or optical retro-modulator 300. As such, metal used may vary, depending on electrical and/or optical qualities, manufacturing concerns, and the like. In some embodiments, the reflective element 330 may comprise gold deposited on the QWM 320. In alternative embodiments, the reflective element 330 may be coupled to the QWM 320 using other means. Because the manufacture of the QWM 320 may result in a substantially flat surface to which the reflective element 330 is attached, the reflective element 330 itself may be substantially flat (as opposed to, for example, a cat's-eye retroreflector that utilizes a curved mirror). It can be additionally noted that, in embodiments where the reflective element comprises a metallic or other electrically-conductive material, the conductivity of the reflective element 330 may additionally improve the performance of the QWM 320 by reducing sheet resistance.

The illustrated components of the optical retro-modulator 300 may be housed in a body (not shown), the shape and/or material of which may vary, depending on desired functionality. In some embodiments, the optical retro-modulator 300 may be included in a larger optical tag that further includes house circuitry for the QWM 320 (that may be configured to receive a data input and provide modulation of the light 360 by applying a switching voltage to the QWM 320), an optical receiver (that also may be configured to receive incoming light 360 and, where the incoming light 360 is modulated to provide a data signal, extract the data), a power source (e.g., battery), additional optics, and the like.

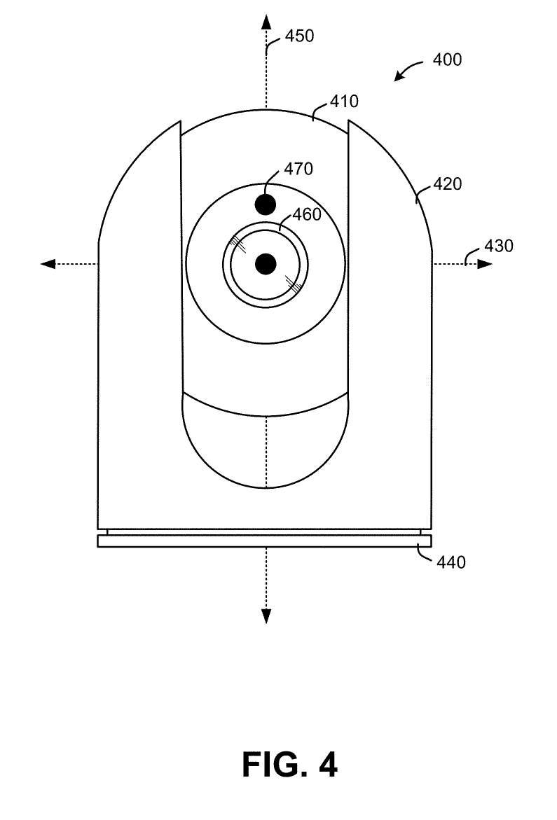

FIG. 4 is an illustration of an embodiment of an optical tag 400, according to an embodiment. (This optical tag 400 may, for example, be utilized as the optical tag 120 illustrated in FIG. 1.) It will be understood, however, that optical tags may comprise any of a variety of different shapes and designs, depending on application and desired functionality.

In this embodiment, the optical tag 400 comprises a gimbal design, in which a circular body 410 is mounted to a support structure 420 in a way that enables the circular body 410 to rotate around a horizontal axis 430. The support structure 420 may be attached to a base 440 that also provides rotation, enabling the support structure 420 to rotate around a vertical axis 450. In some embodiments, the optical tag 400 may house one or more electric motors, allowing the rotation around the vertical axis 450 and/or horizontal axis 430 to be motorized.

The circular body 410 may house an optical retro-modulator, such as the optical retro-modulator 300 of FIG. 3. As previously mentioned, a relatively large aperture is desired for the optical retro-modulator (helping to increase the amount of light reflected by the optical retro-modulator and reduce divergence of reflected laser light). Thus, the optical retro-modulator aperture 460 may be sized accordingly.

The circular body 410 may also include a light receiver aperture 470. As noted above, a light receiver can be used in conjunction with an optical retro-modulator to detect laser light and, where the laser light includes a modulated signal, extract data from the modulated signal. In designs (such as optical tag 400) in which the optical tag may be pointed at a laser source, the light receiver may also be used for tracking a laser source. In some embodiments, an optical tag may include an optical assembly in which a light receiver and optical retro-modulator share an objective lens or other optics, in which case the optical tag may have a single aperture.

The gimbal functionality of the optical tag 400 allows the optical retro-modulator to be pointed at an active component (e.g., laser transmitter) of an optical communication system. As such, a wide overall FOV may not be needed. Instead, the optical tag 400 may include additional magnification optics to help achieve a practical FOV and increase in intensity of the reflected laser light. (Some embodiments include a 1° FOV. Other embodiments may utilize a larger or smaller FOV.)

Embodiments of an optical tag may vary in shape, composition, and design. Materials for the various components of the optical tag may be selected based on impact resistance, thermal resistance, and/or other considerations. Sizes, too, can vary. In one embodiment, the diameter of the light receiver aperture 470 is 3 mm, the diameter of the optical retro-modulator aperture 460 is 25 mm, and the diameter of the base is 70 mm. Of course, alternative embodiments may have different sizes, depending on desired functionality. Alternative embodiments may not include a gimbal design, may be movable in some other fashion, and/or may not be otherwise movable, which again may depend on application (e.g., applications in which optical communication may occur within close range, a smaller, static design having a wide FOV may be used).

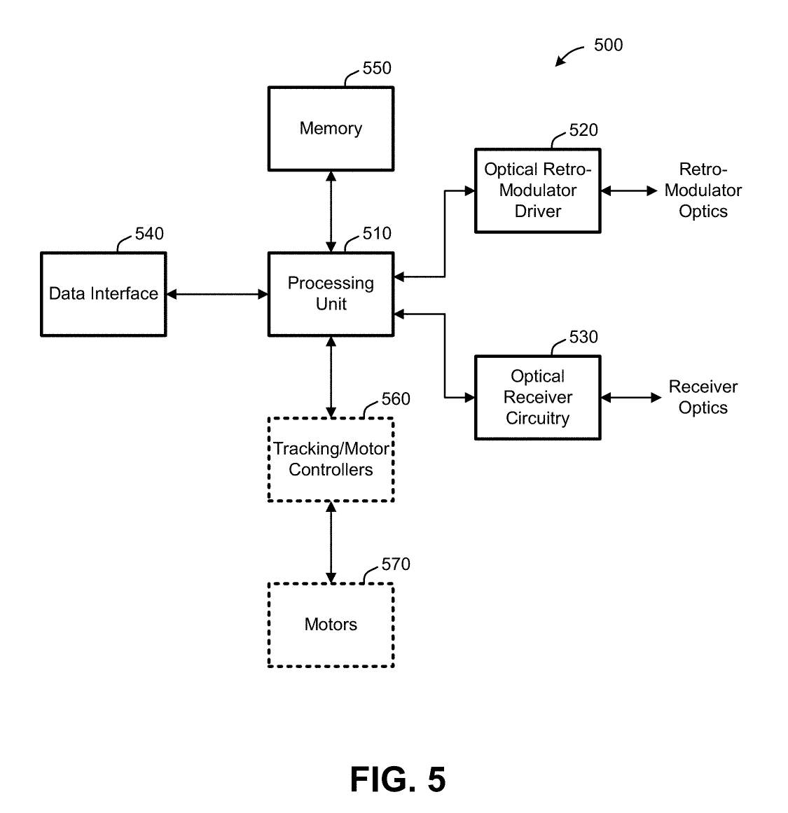

FIG. 5 is a block diagram 500 of the electrical components of an optical tag, according to an embodiment. Here, components include a processing unit 510, optical retro-modulator driver 520, optical receiver circuitry 530, data interface 540, and memory 550. Optional components, tracking/motor controllers 560 and motors 570 are outlined with dashed lines. It will be understood, however, that alternative embodiments may include additional or alternative components. Moreover, components may be combined and/or separated, depending on desired functionality. A person of ordinary skill in the art will appreciate that additional components (such as a battery or other power source) are not illustrated.

Here, data can be communicated to and/or from the optical tag using a data interface 540. This may comprise, for example, an interface capable of sending and/or receiving wired and/or wireless (RF, optical, etc.) communications with another device, such as a computer system. In the optical communication system 100 of FIG. 1, for example, the aerial vehicle 130 may include an onboard computer communicatively coupled with the optical tag 120 via its data interface 540. For physical (wired) communications, the data interface 540 may comprise one or more physical ports, which may vary depending on communication standards utilized.

The optical retro-modulator driver 520 may comprise circuitry, as indicated above, for driving the modulator of the optical retro-modulator (e.g., the optical retro-modulator 300 illustrated in FIG. 3). As such, it may be configured to provide a switching voltage to the modulator of the optical retro-modulator to cause the modulator to modulate the light reflected by the optical retro-modulator with a data signal. As previously indicated, switching speeds and voltages vary, and may be dictated by the physical properties of the modulator. As such, the optical retro-modulator driver 520 may be configured to accommodate such voltages and speeds. Although data from the processing unit 510 to the optical retro-modulator driver 520 may be typically one directional (flowing from the processing unit 510 to the optical retro-modulator driver 520), some feedback may be provided. As previously indicated, for example, embodiments may include a temperature sensor (not shown), allowing the optical retro-modulator driver 520 to adjust a voltage based on a sensed temperature.

Just as optical retro-modulator driver 520 provides an electrical interface to the retro-modulator optics, the optical receiver circuitry 530 can provide an electrical interface to the receiver optics. As previously indicated, the receiver optics may be capable of capturing laser light. However, because no additional light needs to be reflected back to the laser source, the receiver optics may not need to be as sensitive as the retro-modulator optics. Optical receiver circuitry 530 may comprise an avalanche photodiode (APD) or other light sensor onto which the receiver optics focus received laser light. Optical receiver circuitry 530 may additionally comprise one or more analog-to-digital converters (ADC) to enable the optical receiver circuitry 530 to communicate digitally with the processing unit 510.

The processing unit 510 may comprise without limitation one or more general-purpose processors (e.g. a central processing unit (CPU), microprocessor, and/or the like), one or more special-purpose processors (such as digital signal processing (DSP) chips, graphics acceleration processors, application specific integrated circuits (ASICs), and/or the like), and/or other processing structure or means. The processing unit 510 may be configured to act as a hub to control outgoing and incoming information to the optical tag. And may use memory 550 as a buffer for incoming and/or outgoing data.

For its part, memory 550 may comprise, without limitation, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

In operation, the processing unit 510 may receive data from the data interface 540 to transmit, which it may store in memory 550. Using information from the optical receiver circuitry 530, the processing unit 510 may determine when the optical tag is illuminated with laser light, and when that laser light is suitable for modulation. At that time, the processing unit 510 can then send the data from the memory 550 to the optical retro-modulator driver 520, which can modulate the laser light with the data.

A similar process may take place when receiving data. Data encoded on laser light detected by the receiver may be received by the processing unit 510 via the optical receiver circuitry 530. The processing unit 510 may then relay the data out through the data interface 540 (e.g. to another device, such as a computer system). Optionally, the processing unit 510 may store the data in the memory 550 before sending it out via the data interface 540.

For optical tags (such as the optical tag 400 of FIG. 4) that may be configured to track laser light and/or otherwise aim the optics of the optical tag at a laser source, the optical tag may additionally include tracking/motor controllers 560 and motors 570. In some embodiments, for example, the processing unit 510 may be configured to utilize data received by the optical receiver circuitry 530 (which may be indicative of a brightness of detected laser light) and implement a tracking algorithm in which it controls the motors 570 of the tracking/motor controllers 560 to track the laser light source. (In other embodiments, additional or alternative data sources may be utilized for tracking, including data received from the data interface 540.)

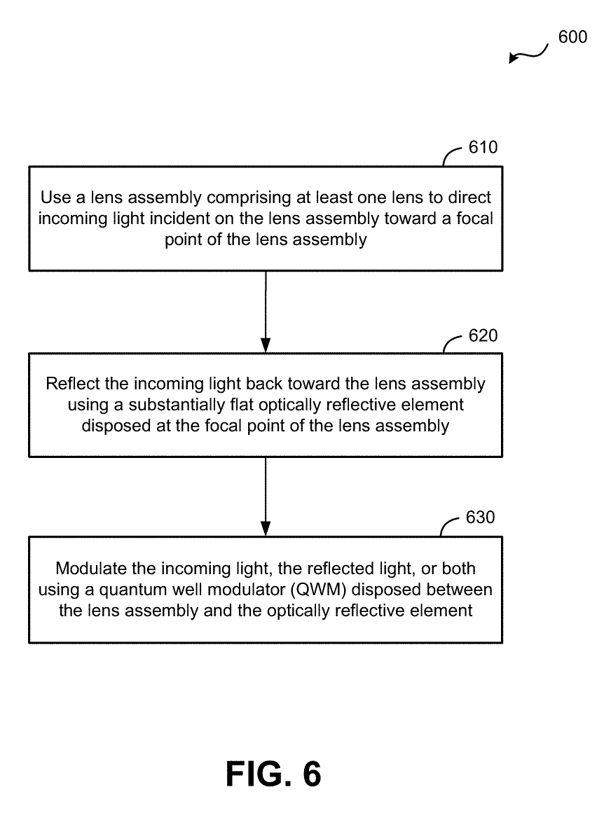

FIG. 6 is a process flow diagram of a method 600 of optical retro-modulation, according to an embodiment. Here, the functionality of the blocks illustrated in FIG. 6 may be performed by one or more elements of an optical retro-modulator, such as the optical retro-modulator 300 illustrated in FIG. 3.

At block 610, the functionality includes using a lens assembly comprising at least one lens to direct incoming light incident on the lens assembly toward the focal point of the lens assembly. As indicated in the embodiments described above, the incoming light may be directed telecentrically toward the focal point of the lens, such that the light is normal to a reflective element located at the focal point of the lens. In some embodiments, telecentricity may be achieved through the use of an aperture stop, which may be part of, or separate from, an optical retro-modulator that comprises the lens assembly. As such, the lens assembly may be configured to enable incoming light incident on the lens assembly to be directed toward the focal point of the lens assembly telecentrically, through the use of an aperture stop and/or by other means.

The functionality at block 620 comprises reflecting the incoming light back toward the lens assembly using a substantially flat optically reflective element disposed at the focal point of the lens assembly. As opposed to a curved mirror, a substantially flat optically reflective element may be significantly easier to manufacture, thereby potentially reducing costs over traditional retroreflective means.

The functionality at block 630 comprises modulating the incoming light, the reflected light, or both, using a QWM disposed between the lens assembly and the optically reflective element. Here, because the QWM can modulate the intensity of light traveling through it in either direction, it may modulate either or both the incoming light or reflected light. (In any case, the light reflected back through the lens assembly is modulated.)

The basic method 600 described in FIG. 6 and in the paragraphs above may include additional variations, as indicated in embodiments previously described herein. For example, in some embodiments, as noted above, the lens assembly may comprise a corrector lens and a second lens, where the corrector lens is configured to direct incoming light toward the second lens. In some embodiments, the second lens may comprise an immersion lens. The QWM may comprise a semiconductor device optically contacted with the immersion lens (e.g., coupled to the immersion lens via an optical contact bond). In some embodiments, the immersion lens may comprise a silicon lens. In some embodiments, the substantially flat optically reflective element may comprise a metallic layer deposited on a surface of the semiconductor device. This metallic layer, in some embodiments, may comprise gold.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including components illustrated in FIG. 5), or may be embodied in sequences of machine-readable, or computer-readable, instructions, which may be used to cause a machine, such as a general-purpose or special-purpose processor (e.g., processing unit 510 of FIG. 5) or logic circuits programmed with the instructions, to perform the methods. These machine-readable instructions may be stored on one or more machine-readable mediums, such as CD-ROMs or other type of optical disks, floppy disks, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

1. An optical retro-modulator comprising:
a lens assembly comprising at least one lens configured to direct incoming light toward a focal point;
a substantially flat optically reflective element disposed at the focal point of the lens assembly and configured to reflect the incoming light from the lens assembly back toward the lens assembly; and
a Quantum Well Modulator (QWM) disposed between the lens assembly and the optically reflective element and configured to modulate the incoming light, the reflected light, or both, traveling between the lens assembly and the optically reflective element.

2. The optical retro-modulator of claim 1, wherein the lens assembly is further configured to direct the incoming light toward the focal point telecentrically, when the optical retro-modulator is used with an aperture stop.

3. The optical retro-modulator of claim 1, wherein:
the QWM comprises a semiconductor device, and
the optically reflective element is disposed on a surface of the semiconductor device such that the incoming light from the lens assembly travels through the semiconductor device.

4. The optical retro-modulator of claim 3, wherein the lens assembly comprises an immersion lens optically contacted with the semiconductor device.

5. The optical retro-modulator of claim 4, wherein the lens assembly further comprises a corrector lens configured to direct the incoming light toward the immersion lens.

6. The optical retro-modulator of claim 3, wherein the optically reflective element comprises a metallic layer deposited on the surface of the optical element.

7. The optical retro-modulator of claim 6, wherein the metallic layer comprises gold.

8. The optical retro-modulator of claim 3, wherein the lens assembly comprises a silicon lens.

9. A method of optical retro-modulation comprising:
using a lens assembly comprising at least one lens to direct incoming light incident on the lens assembly toward a focal point of the lens assembly;
reflecting the incoming light back toward the lens assembly using a substantially flat optically reflective element disposed at the focal point of the lens assembly; and
modulating the incoming light, the reflected light, or both, using a Quantum Well Modulator (QWM) disposed between the lens assembly and the optically reflective element.

10. The method of claim 9, further comprising providing an aperture stop such that the lens assembly is configured to direct the incoming light toward the focal point of the lens assembly telecentrically.

11. The method of claim 9, wherein:
the QWM comprises a semiconductor device, and
the optically reflective element is disposed on a surface of the semiconductor device such that the incoming light from the lens assembly travels through the semiconductor device.

12. The method of claim 11, wherein the lens assembly comprises an immersion lens optically contacted with the semiconductor device.

13. The method of claim 12, wherein the lens assembly further comprises a corrector lens configured to direct the incoming light toward the immersion lens.

14. The method of claim 11, wherein the optically reflective element comprises a metallic layer deposited on the surface of the semiconductor device.

15. An optical device comprising:
a lens assembly comprising a corrector lens and an immersion lens, the lens assembly configured to enable incoming light incident on the corrector lens to be directed toward a focal point of the lens assembly telecentrically;
an optically reflective element disposed at the focal point of the lens assembly configured to reflect the incoming light from the lens assembly back toward the lens assembly; and
a modulating optical element disposed between the lens assembly and the optically reflective element, wherein:
the modulating optical element is coupled to the immersion lens of the lens assembly via an optical contact bond, and
the modulating optical element comprises a Quantum Well Modulator (QWM) configured to modulate the incoming light, the reflected light, or both, traveling between the lens assembly and the optically reflective element.

16. The optical device of claim 15, wherein the optically reflective element comprises a metallic layer disposed on a surface of the modulating optical element.

17. The optical device of claim 16, wherein the metallic layer comprises gold.

18. The optical device of claim 15, wherein the immersion lens comprises a silicon lens.
